(19) United States
(12) Patent Application Publication
(10) Pub. No.: US 2009/0134227 A1
(43) Pub. Date: May 28, 2009

(54) Spatial Security Features

(76) Inventor: Joseph D. Roth, Springboro, OH (US)

Correspondence Address: CHARLES MANEY;NCR CORPORATION, LAW DEPT., 1700 S. PATTERSON BLVD., DAYTON, OH, 45479-0001, US

(21) Appl. No.: 12/045,108

(22) Filed: Mar. 10, 2008

Related U.S. Application Data
(60) Provisional application No. 60/990,217, filed on Nov. 26, 2007.

(51) Int. Cl. G06K 19/06

(52) U.S. Cl. 235/491

(57) ABSTRACT

A security feature is created by printing a patch of photoluminescent material on a substrate and printing a representation of a first barcode over the patch of photoluminescent material using a material selected to absorb radiation at one or more wavelengths that would cause the photoluminescent material to luminesce.

### RELATED APPLICATIONS

This application claims the benefit of U.S. Provisional Patent Application Ser. No. 60/990,217, filed on Nov. 26, 2007, entitled Spatial Security Features.

### BACKGROUND

Barcodes are often used to identify the item to which they are attached. Such barcodes, like the items they identify, can sometimes be counterfeited.

### SUMMARY

In general, in one aspect, the invention features a method for creating a security feature. The method includes printing a patch of photoluminescent material on a substrate. The method further includes printing a representation of a first barcode over the patch of photoluminescent material using a material selected to absorb radiation at one or more wavelengths that would cause the photoluminescent material to luminesce.

Implementations of the invention include one or more of the following. Printing the representation of the first barcode may include printing a negative of the first barcode using the material selected to absorb radiation. The material selected to absorb radiation may include a UV absorbent material. Printing the patch of photoluminescent material on the substrate may include using non-variable data print technology. Printing the representation of the first barcode over the patch of photoluminescent material using the material selected to absorb radiation may include using variable data print technology. The method may further include printing a representation of a second barcode over the patch of photoluminescent material proximate to the representation of the first barcode using a material selected to be visible against a background of the photoluminescent material and the substrate in ambient light and under radiation at one or more wavelengths that would cause the photoluminescent material to luminesce.

In general, in another aspect, the invention features a security feature including a patch of photoluminescent material printed on a substrate. The security feature further includes a representation of a first barcode printed over the patch of photoluminescent material using a material selected to absorb radiation at one or more wavelengths that would cause the photoluminescent material to luminesce.

Implementations of the invention may include one or more of the following. The representation of the first barcode may include a negative of the first barcode printed using the material selected to absorb radiation. The material selected to absorb radiation may include a UV absorbent material. The patch of photoluminescent material may be printed on the substrate using a non-variable data print technology. The representation of the first barcode over the patch of photoluminescent material may be printed using a variable data print technology. The security feature may further include a representation of a second barcode printed over the patch of photoluminescent material proximate to the representation of the first barcode using a material selected to be visible against a background of the photoluminescent material and the substrate in ambient light and under radiation at one or more wavelengths that would cause the photoluminescent material to luminesce.

In general, in another aspect, the invention features a method for creating a covert barcode, including applying a masking patch to a substrate, applying a transparent luminescent material over the masking patch, applying a laser imageable material over the transparent luminescent material, and exposing the laser imageable material to a laser to create the covert barcode.

In general, in another aspect, the invention features a covert barcode including a masking patch applied to a substrate, a transparent luminescent material applied over the masking patch, a laser imageable material applied over the transparent luminescent material, and a covert barcode created by exposing the laser imageable material to a laser.

In general, in another aspect, the invention features a method for creating a covert barcode and an overt barcode, including affixing a first laser imageable material to a substrate, affixing a second laser imageable material to the substrate, exposing the first laser imageable material to a laser to create the covert barcode, and exposing the second laser imageable material to a laser to create the overt barcode.

Implementations of the invention may include one or more of the following. The method may include affixing a first masking patch to the substrate at least below the first laser imageable material, and applying a first transparent luminescent material between the first masking patch and the first laser imageable material, wherein the color of the first masking patch in the visible spectrum matches the imaged color of the first laser imageable material in the visible spectrum under ambient light. The method may further include affixing a second masking patch to the substrate at least below the second laser imageable material, wherein the color of the second masking patch in the visible spectrum is different from the imaged color of the second laser imageable material in the visible spectrum such that the overt barcode is visible under ambient light against the background of the second masking patch. Affixing the first masking patch to the substrate at least below the first laser imageable material may include affixing the first masking patch to the substrate at least below the first and the second laser imageable materials, and the color of the first masking patch in the visible spectrum may be different from the imaged color of the second laser imageable material in the visible spectrum such that the overt barcode is visible under ambient light against the background of the first masking patch.

In general, in another aspect, the invention features a covert barcode and an overt barcode including a first laser imageable material affixed to a substrate, a second laser imageable material affixed to the substrate, a covert barcode created by exposing the first laser imageable material to a laser, and an overt barcode created by exposing the second laser imageable material to a laser.

Implementations of the invention may include one or more of the following. The covert barcode and the overt barcode may include a first masking patch affixed to the substrate at least below the first laser imageable material, and a first transparent luminescent material applied between the first masking patch and the first laser imageable material, wherein the color of the first masking patch in the visible spectrum matches the imaged color of the first laser imageable material in the visible spectrum under ambient light. The covert barcode and the overt barcode may include a second masking patch affixed to the substrate at least below the second laser imageable material, wherein the color of the second masking patch in the visible spectrum is different from the imaged color of the second laser imageable material in the visible spectrum such that the overt barcode is visible under ambient light against the background of the second masking patch. The first masking patch may be affixed to the substrate at least below the first and the second laser imageable materials, and the color of the first masking patch in the visible spectrum may be different from the imaged color of the second laser imageable material in the visible spectrum such that the overt barcode is visible under ambient light against the background of the first masking patch.

In general, in another aspect, the invention features a method for identifying an item. The method includes reading an overt barcode associated with the item, radiating a covert barcode associated with the item, causing the covert barcode to luminesce, reading the luminescing covert barcode, and using data read from the overt barcode and data read from the covert barcode to identify the item.

Implementations of the invention may include one or more of the following. The overt barcode may be attached to the item. The covert barcode may be attached to the item. The overt barcode and the covert barcode may be attached to the item. The overt and covert barcodes may include a single security feature.

### BRIEF DESCRIPTION OF THE DRAWINGS

FIGS. 1, 4, 5, 8, and 9 show embodiments of spatial security features.

FIG. 2 shows a spatial security feature illuminated by ultraviolet light.

FIGS. 3 and 7 shows flow charts illustrating the use of a spatial security feature.

FIG. 6 illustrates the creation of a barcode as part of a spatial security feature.

FIG. 10 is a flow chart for the use of a spatial security feature.

### DETAILED DESCRIPTION

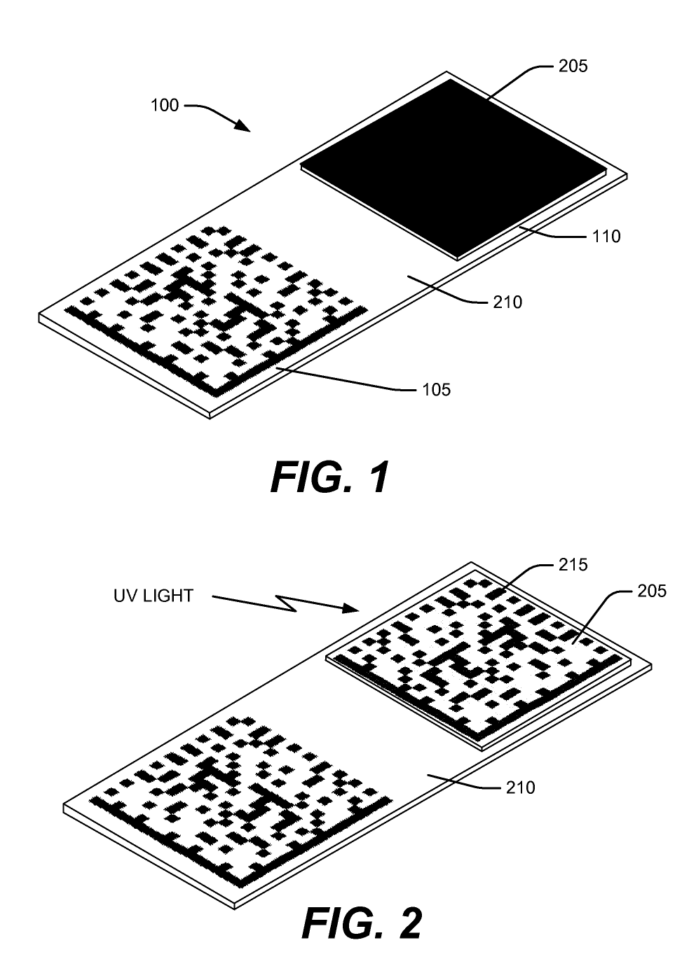

A spatial security feature 100 includes an overt feature 105 and a covert feature 110 on a substrate 210, as shown in FIG. 1. The overt feature 105, shown as a two-dimensional bar code, is visible to the unaided eye under normal (e.g., ambient) light conditions. The covert feature 110, which may similarly be in the form of a two-dimensional barcode, is invisible to the unaided eye under normal (e.g., ambient) light conditions. It should be noted that while the covert feature 110 is shown as black in FIG. 1, it may be any color or colorless under normal lighting. In a preferred embodiment, the color of the covert feature 110 is selected to match or be transparent with respect to the color of the substrate 210 under normal (e.g., ambient) light conditions.

The overt feature 105 can include a visible image, such as a barcode, printed with any suitable material and/or technique such as, but not limited to, inkjet, laser, impact (e.g., dot matrix), thermal (e.g., direct and/or thermal transfer), lithographic, flexographic, gravure, and the like. In a preferred embodiment, the overt feature is variably printed using a variable print technology (e.g., via inkjet, laser, impact, thermal, and the like) for enhanced security.

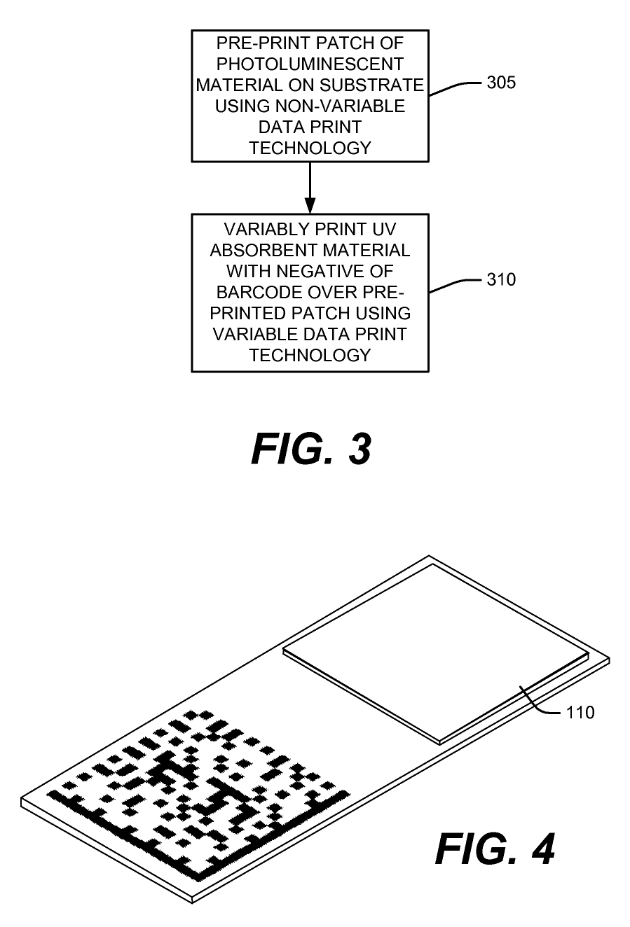

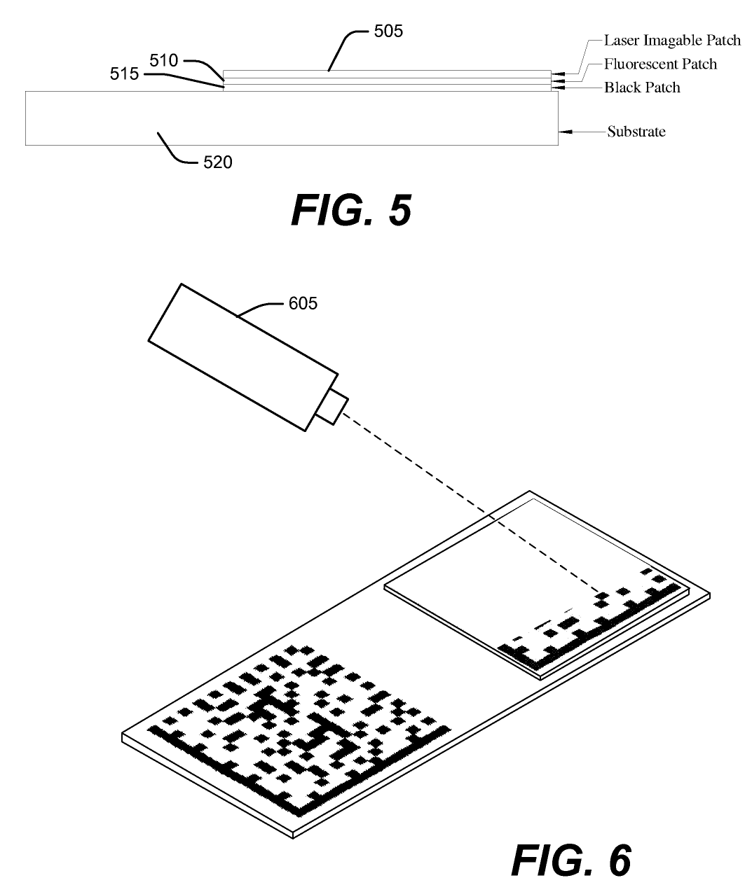

The covert feature 110 can include a patch of photoluminescent material 205 printed on or otherwise applied to a substrate 210 proximate to the overt feature 105, as shown in FIGS. 1 and 2. The photoluminescent material 205 can include a “luminophore,” which is a compound or composition that undergoes luminescent (e.g., fluorescent and/or phosphorescent) emission at one or more characteristic emission wavelengths (e.g., exhibits emission peaks) when excited by an illumination source of a given wavelength (e.g., infrared (IR) and/or ultraviolet (UV) light). The photoluminescent material 205 may be applied to the substrate (block 305), as shown in FIG. 3, by using a non-variable data print technology such as flexographic or lithographic printing through use of a suitable flexographic or lithographic press.

As shown in FIG. 2, the patch of photoluminescent material 205 can be overlaid by an image formed from or in a material 215 that absorbs light of a wavelength which excites the luminophore in the photoluminescent material 205 to luminesce (e.g., a material which absorbs IR and/or UV light). The overlaid absorbing material 215 is shown in FIG. 2 as numerous small black squares in the form of a two-dimensional covert barcode. In alternate embodiments, a negative image, such as a negative of the two-dimensional covert barcode of FIG. 2, may be printed with the overlaid absorbing material 215. The absorbent material 215 may be printed or otherwise applied on top of the invisible photoluminescent material 205 (block 310, see FIG. 3) using variable data printing technology such as, but not limited to, inkjet, laser, impact (e.g., dot matrix), thermal (e.g., direct and/or thermal transfer), and the like.

It will be understood that the photoluminescent material 205 is not limited to material that luminesces in the presence of UV light. The photoluminescent material 205 may luminesce in the presence of light of other wavelengths. Similarly the absorbent material 215 may absorb light of wavelengths other than UV. In general the absorbent material 215 absorbs light that would cause the photoluminescent material 205 to luminesce and/or absorbs light at wavelengths at which the photoluminescent material 205 luminesces. Likewise, the absorbent material 215 may additionally or alternatively scatter light that would cause the photoluminescent material 205 to luminesce and/or scatter light at wavelengths at which the photoluminescent material 205 luminesces.

In general, the absorbent material 215 is selected such that it is transparent or its color matches that of the photoluminescent material 205 under ambient light conditions, thereby rendering a pattern printed in or with the absorbent material 215 (e.g., the two-dimensional barcode of FIG. 2) invisible under ambient conditions. For example, in one embodiment, the absorbent material 215 does not absorb visible light and is, as such, transparent or white under ambient light conditions. In another embodiment, the photoluminescent and absorbent materials 205, 215 are black (e.g., absorb all wavelengths) in ambient visible light, rendering the two-dimensional barcode of FIG. 2 “invisible” as shown in FIG. 1. However, when exposed to light at a wavelength at which the absorbent material 215 is selected to absorb and the photoluminescent material 205 is selected to luminesce (e.g., UV light), the areas with the absorbent material 215 appear as dark portions (e.g., small squares) in a background of light, as shown in FIG. 2. Using this method, dynamic covert barcodes or other covert (re. secure) information can be printed.

As disclosed above, the photoluminescent material 205 may be chosen to have a color other than black, such as white, in ambient (e.g., visible) light. Similarly, the absorbent material 215 may be chosen to have the same color (e.g., white), or be transparent in ambient (e.g., visible) light. In that case, the covert barcode 110 would appear as a patch of the chosen color (e.g., white) in ambient (e.g., visible) light, as shown in FIG. 4.

Likewise, in some embodiments, an overt feature 105 can include a patch of photoluminescent material 205 printed (e.g., by a non-variable data print technology) on or otherwise applied to a substrate 210 such that the photoluminescent material 205 underlies the overt feature 105, wherein the color of the overt feature 105 is different from the color of the photoluminescent material 205 and/or the substrate 210 when viewed under ambient light conditions rendering the overt feature 105 visible (re. overt). Depending on the embodiment, the overt feature 105 may comprise a material which absorbs and/or scatters light that would cause the underlying photoluminescent material 205 to luminesce, and/or absorbs and/or scatters light at wavelengths at which the photoluminescent material 205 luminesces, thereby permitting the overt feature to be read upon excitation of and luminescence by the associated photoluminescent material 205. Further, in some embodiments, the photoluminescent material 205 underlying the overt feature 105 may be the same as the photoluminescent material 205 underlying an associated covert feature 110 comprising a security feature 100 such that the overt and covert features 105, 110 may be simultaneously or substantially simultaneously read through excitation and luminescence at one or more common wavelengths using a common (single) scanner/reader.

### Inkjet Embodiment

The security features 100 and methods illustrated in FIGS. 1-4 increase the number of materials (e.g., inks) available to produce a covert security feature 110 such as a luminescent barcode. For example, only a small number of inkjetable fluorescent materials (e.g., inks) exist. Thus, direct inkjeting of fluorescent barcodes is limited to these inks. However, the subject method allows the user to choose from a larger set of flexographic and lithographic photoluminescent materials 205, such as inks and/or the above described silicon carrier incorporating one or more rare earth elements for producing a desired covert security feature such as a luminescent barcode. Only one inkjetable absorptive material 215 (e.g., ink) needs to be developed to work with all of the photoluminescent materials 205. Further, flexographic and lithographic techniques put down more material than inkjet, which allows for more intense luminescence and better environmental performance, especially fade resistance.

### Laser Imageable Ink Embodiment

Another embodiment uses laser imageable materials (LIM's) as the absorbing material 215 for variable printing of, for example, a covert barcode. The company Datalase (http://www.datalase.com) sells a number of inks which contain LIMs for marking with a CO₂ laser. The LIM is clear (e.g., invisible) before exposure to the laser. After exposure to an appropriate laser the exposed portions of the LIM turn a visible color.

One embodiment includes 3 layers, as shown in FIG. 5. The top layer 505 is the LIM. In the example illustrated in FIG. 5, the imaged color of the LIM is black, although other colors are possible. The second layer 510 is an invisible (e.g., transparent) luminescent (e.g., UV fluorescent) material. The bottom layer 515 is the same color as the imaged LIM (e.g., black). The purpose of the bottom layer is to hide or mask the imaged LIM (e.g., the imaged portion of the LIM in the top layer 505 is not discernable against the background provided by the bottom layer 515 through the transparent luminescent material 510 as the color of the imaged portion of the LIM in the top layer 505 and the color of the bottom layer 515 are the same (e.g., black) under ambient light conditions).

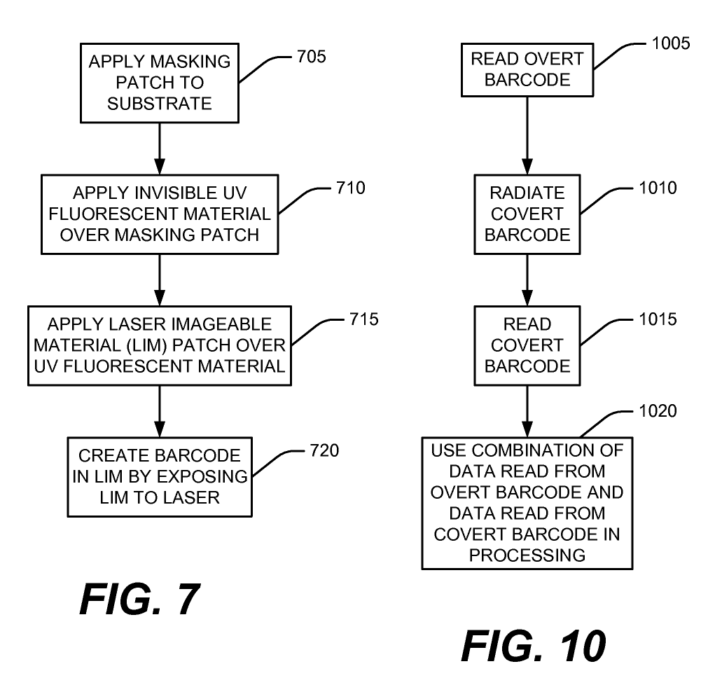

To create a covert image such as a barcode, a masking patch 515 is applied to a substrate 520 (block 705), as shown in FIGS. 5 and 7. An invisible (e.g., UV fluorescent) material 510 is then applied over the masking patch 515 (block 710). A LIM patch 505 is then applied over the UV fluorescent material 510 (block 715). A laser 605 is then used to create a covert image, such as a barcode image, in the LIM layer (block 720), as shown in FIG. 6. In FIG. 6, the laser 605 is shown “drawing” the covert image in the LIM layer. The imaged LIM absorbs excitation (e.g., UV) light and/or the luminescent color emitted from the middle layer. It should be noted that the imaged, covert LIM barcode is visible against the background of the masking material 515 in FIG. 6 for illustration purposes only.

Using this technique allows:
All layers to be applied with flexographic, lithographic or gravure printing methods. This allows higher coat weights as compared to inkjet printing.
Large selection of commercially available fluorescent inks.
The high linespeeds associated with flexographic, lithographic or gravure printing methods.
The minimum print size of the laser is much smaller than other methods. This results in much higher print density, improving resolution, permitting smaller image print sizes and enhancing print quality.
The print quality of the laser is very good, especially for very small images.

Two other variations using laser imageable materials are:
The laser imageable material changes from invisible UV absorptive to invisible non-UV absorptive.
The laser imageable material changes from invisible non-UV absorptive to invisible UV absorptive.

These variations are similar to the one mentioned above except that the need to print/include a color patch 515 underneath the laser imageable material 505 is removed.

Further, in additional embodiments, as shown in FIG. 8, LIMs can be used in a security feature 805 to create an overt barcode 810 and a covert barcode 815. For example, in one embodiment, a first LIM 820 may be used to print or otherwise image an overt barcode wherein the first LIM 820 is selected to image in a color different from the color of a substrate 825 and/or a provided background layer (e.g., a first bottom layer 830) underlying the first LIM when viewed under ambient light conditions. Further, such first LIM 820 may be applied over a first transparent luminescent material 835 situated between the first LIM 820 and the substrate 825 and/or first bottom layer 830. Likewise, a second LIM 840 may be used to print or otherwise image a covert barcode wherein the second LIM 840 is selected to image in a color the same as the color of the substrate 825 and/or a provided background layer (e.g., a second bottom layer 845) underlying the second LIM when viewed under ambient light conditions. Further, such second LIM 840 may be applied over a second transparent luminescent material 850 situated between the second LIM 840 and the substrate 825 and/or second bottom layer 845. Depending on the embodiment, the first LIM 820 may be the same as the second LIM 840, the first luminescent material 835 may be the same as the second luminescent material 850, and/or (where appropriate) the first bottom layer 830 may be the same as the second bottom layer 845. Likewise, in some embodiments, one or both of the first LIM 820 and/or the second LIM 840 may image to be UV absorbing.

### Direct Thermal Embodiment

In another embodiment, shown in FIG. 9, a covert barcode 905 is created by placing a clear direct thermal coating 910 over an invisible luminescent (e.g., fluorescent) coating 915 on a substrate 920. Upon exposure to heat the direct thermal coating changes from UV transparent to UV absorbing. Both forms of the direct thermal coating are transparent to visible light. In this way a direct thermal printer can be used to make invisible print. When a sample is exposed to UV light the thermally printed areas show up as dark portions in a background of light. Under normal lighting conditions the thermal printing is invisible.

### Photochromic Variation

In another embodiment, the patch of fluorescent material is replaced by a patch of photochromic material covered by an absorbing (e.g., UV absorbing) material. The photochromic material under the absorber will not change color when the label is exposed to appropriate (e.g., UV) light. Depending on the embodiment, one or both of the photochromic and absorbing material may be invisible under ambient light conditions.

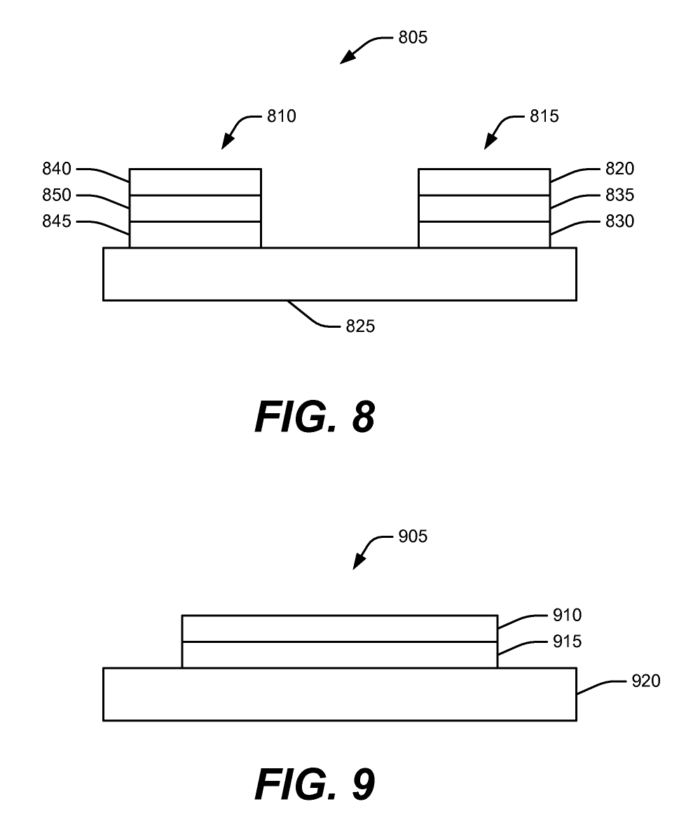

In use, as shown in FIG. 10, a reader such as a barcode reader (not shown) reads (e.g., illuminates and scans) an overt feature 105 (e.g. barcode) of a security feature 100 (block 1005). The barcode reader then radiates a covert feature 110 (e.g., barcode) of the security feature 100 with light of a wavelength that causes the covert feature (e.g., barcode) to luminesce (block 1010). The barcode reader then reads (e.g., scans) the covert feature 110 (e.g., barcode) (block 1015). A combination of the data read from the overt feature (barcode) and data read from the covert feature (barcode) is then used in processing (block 1020) for, for example, security purposes. For example the combination of data may be used to uniquely identify the item to which the overt barcode and the covert barcode (e.g., the security feature 100) are applied. In another embodiment, the covert feature 110 (e.g., barcode) is radiated and then the overt feature 105 (e.g., barcode) and the covert feature 110 (e.g., barcode) are read (i.e., blocks 805 and 810 are reversed). In another embodiment, the overt feature 105 (e.g., barcode) and the covert feature 110 (e.g., barcode) are simultaneously or substantially simultaneously illuminated and/or read.

Likewise, depending on the embodiment, a security feature 100 comprising an overt and a covert feature (e.g., barcodes) 105, 110 may be associated with an item for security purposes through series and/or parallel reading of the overt and covert features 105, 110, which reading ideally occurs after the security feature 100 is affixed to the item and/or associated packaging. Once read, a relationship between the security feature 100 and the marked item, including a relationship between the overt and the covert features 105, 110 themselves, can be stored in a database (e.g., a trusted management system, or TMS) that will maintain the correct relationship between the features (e.g., barcodes) and the item. Authentication is accomplished by reading both the overt and the covert features 105, 110, processing the resultant signal, and using the database to confirm the correct association. Further details surrounding secure identification and trusted management systems may be found in U.S. patent application Ser. No. 11/607,705 entitled “Tagging Items With a Security Feature” and filed on 1 Dec. 2006, Ser. No. 11/601,278 entitled “Secure Reader for use in Data Management” and filed on 17 Nov. 2006, and Ser. No. 11/601,279 entitled “Data Management” and filed on 17 Nov. 2006, the entire contents of which are hereby incorporated by reference herein.

It should be noted that, regardless of the embodiment, a utilized photoluminescent material 205, 510 may comprise a silicon carrier (e.g., a glass such as a borosilicate glass) including one or more dopants such as, but not limited to, a photoluminescent dye, a rare earth element (e.g., a lanthanides such as, but not limited to, Terbium and/or Europium), and the like.

Likewise, as disclosed above, it should be noted that, regardless of the embodiment, utilizing the same luminescent material 205, 510 as part of a covert and an overt feature 105, 110 of a security feature 100 permits the two to be read simultaneously or substantially simultaneously as a single image. In this way, if an item or packaging with which they are associated or on which they are attached contains additional, like images (e.g., barcodes) the reader/scanner (e.g., light source and camera) does not see them as they are not printed on top of an expected luminescent background. As such, the complexity of the reader/scanner is cut in half. Ordinarily, in order to read a covert feature 105 (e.g., first barcode) and an overt feature 110 (e.g., second barcode) illumination with two sources (e.g., visible light for the overt barcode and UV light for the covert barcode) and/or reading with two sensors (e.g., visible and UV) are required, and two separate images must be acquired, processed and handled. Likewise, timing (e.g., delay) issues with acquiring two images are eliminated in so far as with a common luminescent material 205, 510, a single image comprising the overt 105 and covert 110 feature may be simultaneously or near simultaneously obtained. This is very useful on printing and manufacturing lines where tagged items and/or packaging may be rapidly moving. Errors introduced by the barcodes moving between images may also be eliminated.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for creating a security feature, the method comprising:
printing a patch of photoluminescent material on a substrate; and
printing a representation of a first barcode over the patch of photoluminescent material using a material selected to absorb radiation at one or more wavelengths that would cause the photoluminescent material to luminesce.

2. The method of claim 1, wherein printing the representation of the first barcode comprises printing a negative of the first barcode using the material selected to absorb radiation.

3. The method of claim 1, wherein the material selected to absorb radiation comprises a UV absorbent material.

4. The method of claim 1, wherein printing the patch of photoluminescent material on the substrate comprises:
using non-variable data print technology.

5. The method of claim 1, wherein printing the representation of the first barcode over the patch of photoluminescent material using the material selected to absorb radiation comprises:
using variable data print technology.

6. The method of claim 1, further comprising printing a representation of a second barcode over the patch of photoluminescent material proximate to the representation of the first barcode using a material selected to be visible against a background of the photoluminescent material and the substrate in ambient light and under radiation at one or more wavelengths that would cause the photoluminescent material to luminesce.

7. A security feature comprising:
a patch of photoluminescent material printed on a substrate; and
a representation of a first barcode printed over the patch of photoluminescent material using a material selected to absorb radiation at one or more wavelengths that would cause the photoluminescent material to luminesce.

8. The security feature of claim 7, wherein the representation of the first barcode comprises a negative of the first barcode printed using the material selected to absorb radiation.

9. The security feature of claim 7, wherein the material selected to absorb radiation comprises a UV absorbent material.

10. The security feature of claim 7, wherein the patch of photoluminescent material is printed on the substrate using a non-variable data print technology.

11. The security feature of claim 7, wherein the representation of the first barcode over the patch of photoluminescent material is printed using a variable data print technology.

12. The security feature of claim 7, further comprising a representation of a second barcode printed over the patch of photoluminescent material proximate to the representation of the first barcode using a material selected to be visible against a background of the photoluminescent material and the substrate in ambient light and under radiation at one or more wavelengths that would cause the photoluminescent material to luminesce.

13. A method for creating a covert barcode, the method comprising:
applying a masking patch to a substrate;
applying a transparent luminescent material over the masking patch;
applying a laser imageable material over the transparent luminescent material; and
exposing the laser imageable material to a laser to create the covert barcode.

14. A covert barcode comprising:
a masking patch applied to a substrate;
a transparent luminescent material applied over the masking patch;
a laser imageable material applied over the transparent luminescent material; and
a covert barcode created by exposing the laser imageable material to a laser.

15. A method for creating a covert barcode and an overt barcode, the method comprising:
affixing a first laser imageable material to a substrate;
affixing a second laser imageable material to the substrate;
exposing the first laser imageable material to a laser to create the covert barcode; and
exposing the second laser imageable material to a laser to create the overt barcode.

16. The method of claim 15, further comprising:
affixing a first masking patch to the substrate at least below the first laser imageable material; and
applying a first transparent luminescent material between the first masking patch and the first laser imageable material,
wherein the color of the first masking patch in the visible spectrum matches the imaged color of the first laser imageable material in the visible spectrum under ambient light.

17. The method of claim 16, further comprising:
affixing a second masking patch to the substrate at least below the second laser imageable material,
wherein the color of the second masking patch in the visible spectrum is different from the imaged color of the second laser imageable material in the visible spectrum such that the overt barcode is visible under ambient light against the background of the second masking patch.

18. The method of claim 16, wherein:
affixing the first masking patch to the substrate at least below the first laser imageable material comprises affixing the first masking patch to the substrate at least below the first and the second laser imageable materials, and
the color of the first masking patch in the visible spectrum is different from the imaged color of the second laser imageable material in the visible spectrum such that the overt barcode is visible under ambient light against the background of the first masking patch.

19. A covert barcode and an overt barcode comprising:
a first laser imageable material affixed to a substrate;
a second laser imageable material affixed to the substrate;
a covert barcode created by exposing the first laser imageable material to a laser; and
an overt barcode created by exposing the second laser imageable material to a laser.

20. The covert barcode and the overt barcode of claim 19, further comprising:
a first masking patch affixed to the substrate at least below the first laser imageable material; and
a first transparent luminescent material applied between the first masking patch and the first laser imageable material,
wherein the color of the first masking patch in the visible spectrum matches the imaged color of the first laser imageable material in the visible spectrum under ambient light.

21. The covert barcode and the overt barcode of claim 20, further comprising:
a second masking patch affixed to the substrate at least below the second laser imageable material,
wherein the color of the second masking patch in the visible spectrum is different from the imaged color of the second laser imageable material in the visible spectrum such that the overt barcode is visible under ambient light against the background of the second masking patch.

22. The covert barcode and the overt barcode of claim 20, wherein:
the first masking patch is affixed to the substrate at least below the first and the second laser imageable materials, and
the color of the first masking patch in the visible spectrum is different from the imaged color of the second laser imageable material in the visible spectrum such that the overt barcode is visible under ambient light against the background of the first masking patch.

23. A method for identifying an item, the method comprising:
reading an overt barcode associated with the item;
radiating a covert barcode associated with the item, causing the covert barcode to luminesce;
reading the luminescing covert barcode; and
using data read from the overt barcode and data read from the covert barcode to identify the item.

24. The method of claim 23, wherein the overt barcode is attached to the item.

25. The method of claim 23, wherein the covert barcode is attached to the item.

26. The method of claim 23, wherein the overt barcode and the covert barcode are attached to the item.

27. The method of claim 23, wherein the overt and covert barcodes comprise a single security feature.
